(19) United States
(12) Patent Application Publication
(10) Pub. No.: US 2006/0282870 A1
(43) Pub. Date: Dec. 14, 2006

(54) Digital video receiving system and its method

(76) Inventor: Chih-Yi Chen, Chung Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/232,918

(22) Filed: Sep. 23, 2005

(30) Foreign Application Priority Data
Jun. 14, 2005 (TW) 094119731

(51) Int. Cl. H04N 7/173; H04N 7/18; H04N 7/16

(52) U.S. Cl. 725/118; 725/81; 725/62; 725/120

(57) ABSTRACT

This invention discloses a digital video receiving system and its method. The system sets a receiving module based on a DVB-T and a DVB-H protocol to receive the digital video of the corresponding DVB-T and DVB-H signal from at least one DVB broadcast transmitter. Furthermore, according to a predetermined receiving mode and a power supply status, the DVB-T mode of the DVB-T protocol or the DVB-H mode of the DVB-H protocol can be selectively set through a determination unit to receive and perform the corresponding digital video. In addition, the determination unit, which may be a circuit or a program, can be respectively auto- or manual-change between the DVB-T mode and the DVB-H mode.

### FIELD OF THE INVENTION

The present invention generally relates to a digital video receiving system and its method and, more particularly, to a portable apparatus having a digital video common mode system.

### BACKGROUND OF THE INVENTION

Since European Telecommunications Standards Institute, ETSI published Digital Video Broadcasting for Terrestrial, DVB-T to be a transmission technology standard in 1997, most countries have used DVB-T system to implement their digital signal broadcast network. When the mobile multimedia environment is coming, the power consumption and the mobile reception for DVB-T signal are two major issues. In 2004, ETSI published Digital Video Broadcasting for Handheld, DVB-H standard suitable for portable apparatuses based on the DVB-T system. In the digital broadcast system, a single channel may include many programs or services. At the broadcast transmitter site, a multiplexer collects the flow video signals, audio signals, and data/information to be a single Transport Stream, TS. The TS is transmitted through modulation. Referring to FIG. 1, a schematic diagram of a segment in the bit-rate dimension in a conventional DVB-T system is illustrated. As shown in FIG. 1, in the DVB-T system, the segment in the bit-rate dimension is segmented that takes a capacity to distribute to each program 11, 12, 13, and 14 of channels. In a receiver, if users would like to watch one of those programs, the receiver should operate without disconnecting that receives signals 15, 16, 17, 18, and 19 of durations in order to decode complete TS. Video signals, audio extension signals, and streams of programs selected from users are separated from the single TS that are then transmitted to a decoder and other application programs for further processing. The arrangement for streams is not an efficient way from a point of view in power consumption. The power consumption in the receiver of a classic DVB-T usually needs at average 1 watt. In order to reduce the power consumption in the receiver, referring to FIG. 2, a schematic diagram of streams arrangement of a conventional DVB-H is illustrated. As shown in FIG. 2, Internet Protocol, IP packets are included in a time-domain of a time-slot (or called a burst duration) with shortly segmented via time-slicing technology that are transmitted by a data burst mode and utilizes a bigger capacity to transmit different programs 11, 12, 13, and 14 at every time-slot by turns. Signals included at every time-slot corresponds to a signal of a single program of single durations 15, 16, 17, 18, and 19 as shown in FIG. 1. If users would like to watch a program 13, receivers only needs to start a reception mode and then receives signals at a time-slot (or called a burst duration) 21. Remaining time is in an idle status without power consumption. In another word, the idle status improves an efficiency of power saving.

In addition, in order to predict next time-slot for same programs, a starting time information (the relative time difference presented by Delta-T) of next time-slot is carried together when information is transmitted by a transmitter with every time-slot. The technology in theory can save the power consumption at average 90%. The technology in a core specification of DVB-H is a necessary technology.

Consequently, the signal receiving may be broken off or the signal receiving time may be reduced due to the power consumption when users use portable apparatuses with low power to receive digital signals of DVB-T. There must be some ways to resolve problems of mentioned above by providing a digital video receiving system and its method.

### SUMMARY OF THE INVENTION

The primary object of the present invention is to provide a digital video receiving system and method. By way of integrating the digital video receiving system of communication protocols of two digital video broadcastings, a determination unit is further added for performing a mode modification. The mode modification provides a better digital video receiving mode for users.

The present invention discloses a digital video receiving system that is applied for a digital video common mode system and comprises at least two receiving modules and a determination unit. Two receiving modules are used for receiving a digital video of a first communication protocol and a digital video of a second communication protocol respectively. The determination unit is used for performing a video receiving mode modification according to a predetermined receiving mode and a power supply status, and processing a corresponding digital video. The first communication protocol is a DVB-T and the second communication protocol is a DVB-H. The determination unit is a detective circuit like an integrated circuit or a detective program. In addition, the determination unit further comprises a switch apparatus that is used for operating manual-change between the DVB-T mode and the DVB-H mode.

Besides, the present invention discloses a digital video receiving method that is used for a digital video common mode system and comprises steps of: providing at least two receiving modules for receiving the digital video of a first communication protocol and the digital video of a second communication protocol respectively; performing a digital video receiving mode modification according to a predetermined receiving mode and a power supply status, and processing a corresponding digital video. The method further comprises providing a DVB-T and a DVB-H to be the first communication protocol and the second communication protocol respectively. The method also comprises providing a detective circuit to be the determination unit like an integrated circuit or a detective program. In addition, a switch apparatus can be set into the determination unit to operate a manual-change between the DVB-T mode and the DVB-H mode.

### BRIEF DESCRIPTION OF THE DRAWINGS

FIG. 1 is a schematic diagram of a segment in the bit-rate dimension in a conventional DVB-T system;

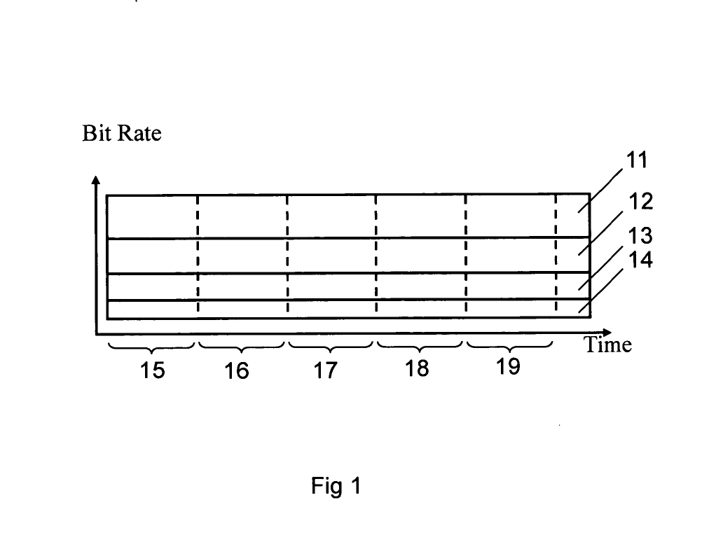

FIG. 2 is a schematic diagram of streams arrangement of a conventional DVB-H;

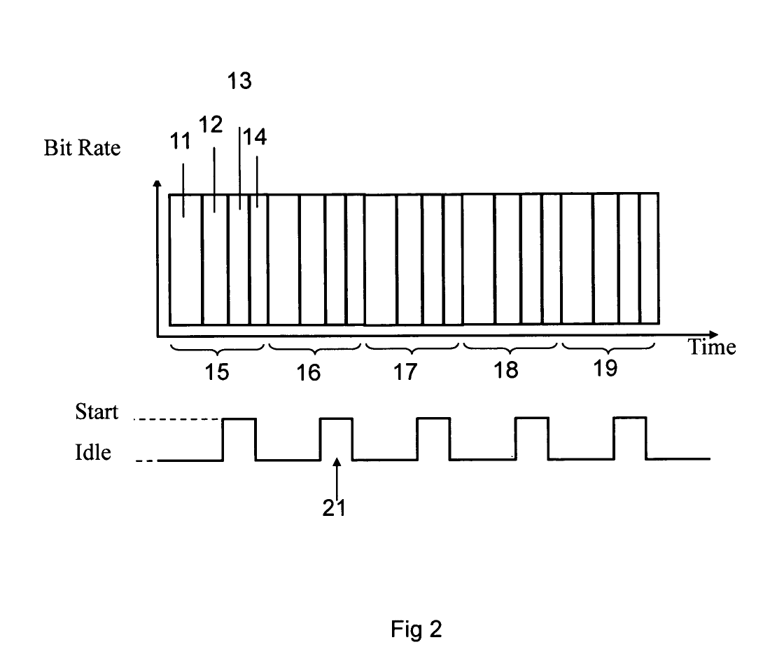

FIG. 3 is a schematic diagram of an example of a transmitter and a receiver of a digital video common mode system according to an embodiment of the present invention;

FIG. 4 is a schematic diagram of an example of a digital video receiving system according to an embodiment of the present invention;

FIG. 5 is a flowchart of an example of a digital video receiving method according to an embodiment of the present invention; and

FIG. 6 is a detail flowchart regarding FIG. 5 according to an embodiment of the present invention.

### DETAILED DESCRIPTION OF THE PREFERRED EMBODIMENTS

Preferred embodiments of the present invention will be explained below with reference to the drawing.

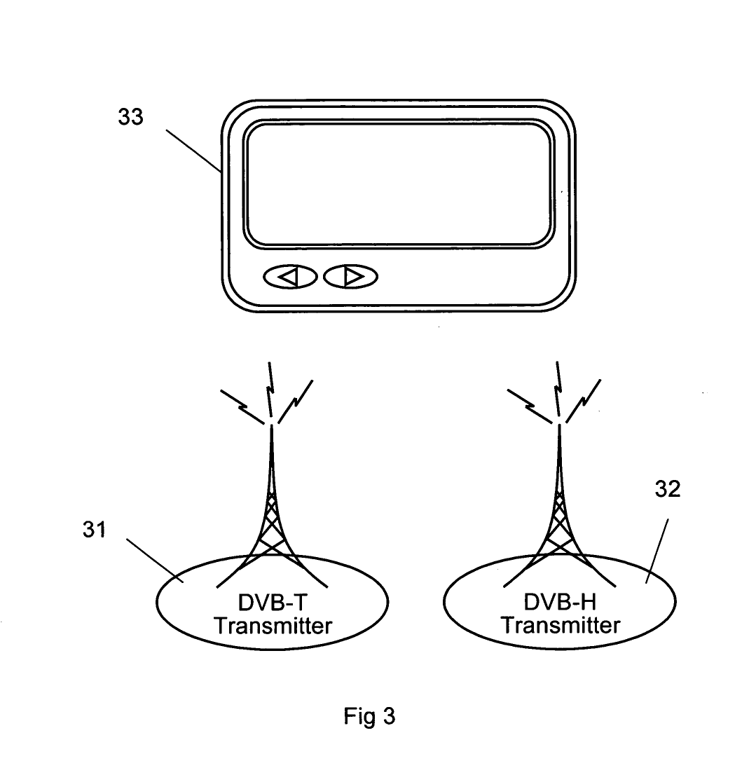

Referring to FIG. 3, a schematic diagram of an example of a transmitter and a receiver of a digital video common mode system according to an embodiment of the present invention is illustrated. The system comprises a DVB-T transmitter 31, a DVB-H transmitter 32, and a portable apparatus receiver 33 of a digital video common mode system. In the preferred embodiment, the portable apparatus receiver 33 is used for receiving a digital video program of DVB-T signal transmitted from the DVB-T transmitter 31 and a digital video program of DVB-H signal transmitted from the DVB-H transmitter 32. The digital video of DVB-T is a transport stream, TS and the digital video of DVB-H is a burst duration of a time slot through the prior art.

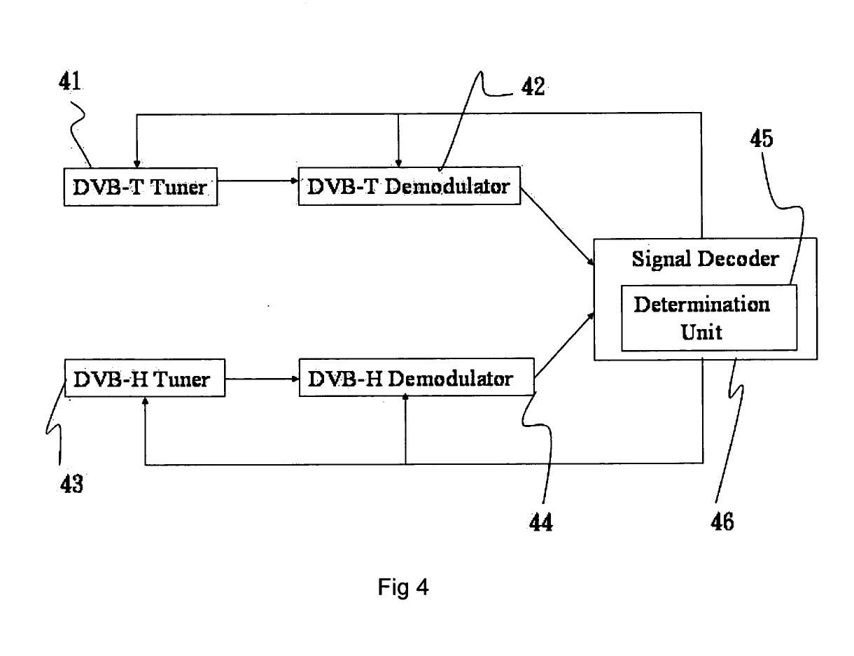

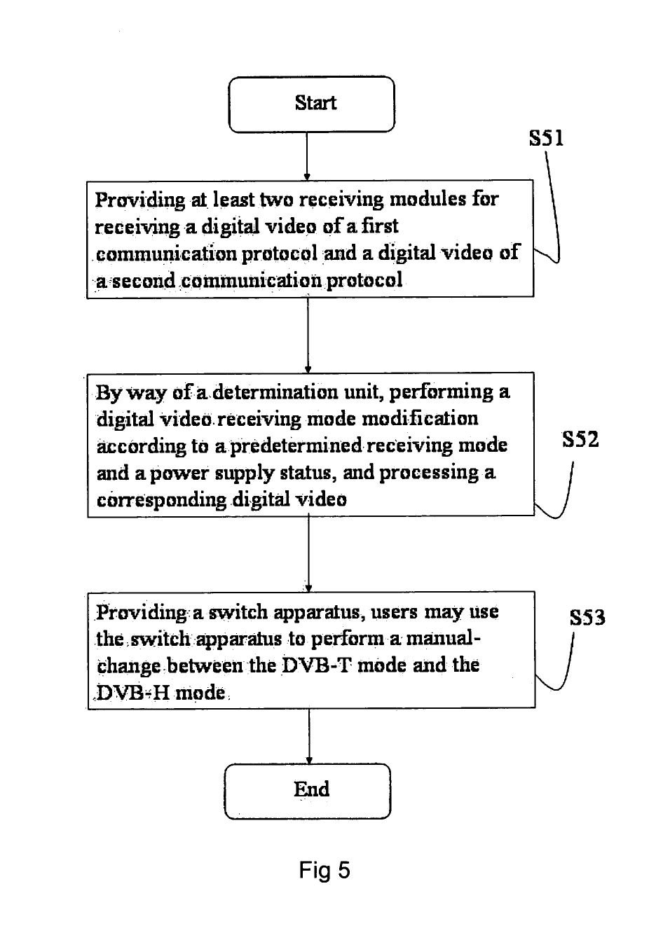

Referring to FIG. 4 and FIG. 5, a schematic diagram of an example of a digital video receiving system and a flowchart of an example of a digital video receiving method according to embodiments of the present invention are illustrated. As shown in FIG. 4, the system comprises a DVB-T tuner 41, a DVB-T demodulator 42, a DVB-H tuner 43, a DVB-H demodulator 44, a signal decoder 45, and a determination unit 46. Instructions can be given to the DVB-T tuner 41 and the DVB-T demodulator 42 to start operations while the determination unit 46 is performing a DVB-T mode. Instructions can be also given to the DVB-H tuner 43 and the DVB-H demodulator 44 to start operations, and the DVB-T tuner 41 and the DVB-T demodulator 42 are shut down if switching to a DVB-H mode.

In the preferred embodiment, the digital video receiving system comprises at least two receiving modules for receiving a digital video of a first communication protocol and a digital video of a second communication protocol respectively. The receiving module at least sets tuners 41, 43, demodulators 42, 44, and the signal decoder 45. The signal decoder 45 further comprises the determination unit 46 which performs a video receiving mode modification according to a predetermined receiving mode and a power supply status, and processes a corresponding digital video. The flowchart in FIG. 5 illustrates the operation in FIG. 4 that comprises steps of: starting, providing at least two receiving modules for receiving a digital video of a first communication protocol and a digital video of a second communication protocol S51, by way of a determination unit, performing a digital video receiving mode modification according to a predetermined receiving mode and a power supply status, and processing a corresponding digital video S52, further providing a switch apparatus, users may use the switch apparatus to perform a manual-change between the DVB-T mode and the DVB-H mode S53, ending procedures of mentioned above.

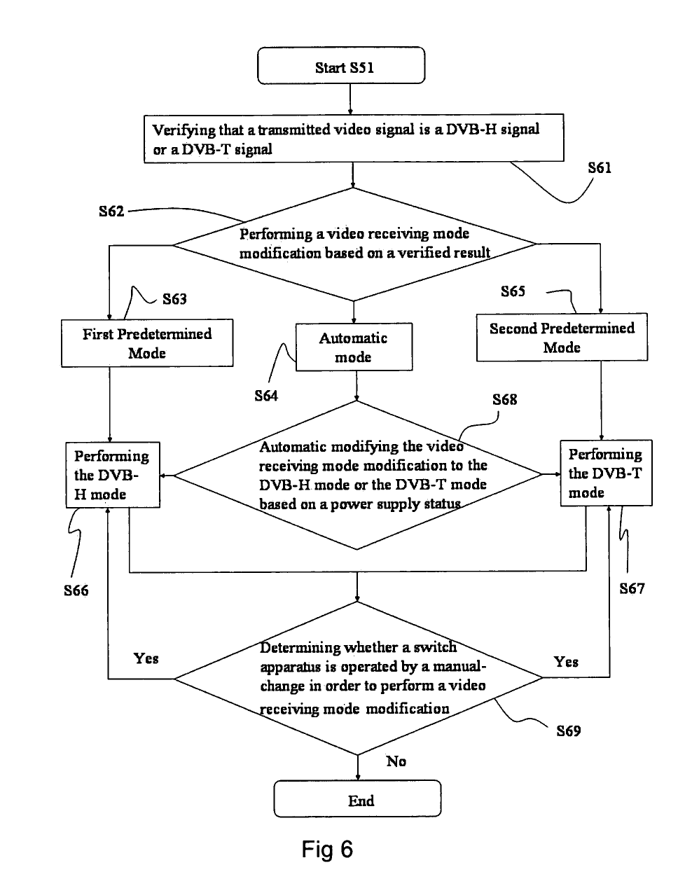

Referring to FIG. 6, illustrates the operation of a detail flowchart regarding S52, S53 in FIG. 5. The flowchart comprises steps of: continuing the procedure S51 in FIG. 5 as starting, verifying that the transmitted video signal is a DVB-H signal or a DVB-T signal S61, performing a video receiving mode modification based on a verified result S62. Next, the video receiving mode modification has three modes that include a first predetermined mode S63, an automatic mode S64, and a second predetermined mode S65. In the first predetermined mode S63, the DVB-H mode is performed S66. The digital video receiving system is used for receiving and displaying a digital video of DVB-H. In the second predetermined mode S65, the DVB-T mode is performed S67. The digital video receiving system is used for receiving and displaying a digital video of DVB-T. In the automatic mode S64, the video receiving mode modification is automatic modified to the DVB-H mode or the DVB-T mode based on a power supply status S68. Moreover, when performing the DVB-H mode S66 or the DVB-T mode S67, further determining whether a switch apparatus is operated by a manual-change in order to perform a video receiving mode modification S69. If yes, the DVB-T mode is performed S67 or the DVB-H mode is performed S66. Otherwise, the procedure is complete. As a result, the receiving module which is in use has an efficiency of power saving. The receiving module is started at a time-slot regarding receiving channels that improves power saving while the DVB-H mode is in use. In addition, users may operate the switch apparatus of the determination unit for performing a manual-change.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A digital video receiving system, being applied for a digital video common mode system, comprising:
at least two receiving modules receiving the digital video of a first communication protocol and the digital video of a second communication protocol respectively; and
a determination unit performing a mode modification based on a predetermined receiving mode and a power supply status, and processing a corresponding digital video.

2. The digital video receiving system of claim 1, wherein the first communication protocol is a DVB-T.

3. The digital video receiving system of claim 1, wherein the second communication protocol is a DVB-H.

4. The digital video receiving system of claim 1, wherein the determination unit is a detective circuit.

5. The digital video receiving system of claim 4, wherein the detective circuit is an integrated circuit.

6. The digital video receiving system of claim 1, wherein the determination unit is a detective program.

7. The digital video receiving system of claim 1, wherein the digital video receiving system further comprises a switch apparatus that is used for a switch manual mode to select the mode modification.

8. The digital video receiving system of claim 1, wherein the mode modification matches a standard protocol of a DVB-T.

9. The digital video receiving system of claim 1, wherein the mode modification matches a standard protocol of a DVB-H.

10. A digital video receiving method, being applied for a digital video common mode system, comprising steps of:
providing at least two receiving modules, receiving the digital video of a first communication protocol and the digital video of a second communication protocol; and
performing a mode modification through a determination unit based on a predetermined receiving mode and a power supply status, and processing a corresponding digital video.

11. The digital video receiving method of claim 10, further comprising providing a DVB-T to be the first communication protocol.

12. The digital video receiving method of claim 10, further comprising providing a DVB-H to be the second communication protocol.

13. The digital video receiving method of claim 10, further comprising providing a detective circuit to be the determination unit.

14. The digital video receiving method of claim 10, further comprising providing a detective program to be the determination unit.

15. The digital video receiving method of claim 10, further comprising providing a switch apparatus, using a manual-change via the switch apparatus for performing the mode modification.

16. The digital video receiving method of claim 10, further comprising providing a first predetermined mode to be the predetermined receiving mode, wherein the first predetermined mode matches a standard protocol of a DVB-H.

17. The digital video receiving method of claim 10, further comprising providing an automatic mode to be the predetermined receiving mode, wherein the automatic mode automatic performs the mode modification based on the power supply status.

18. The digital video receiving method of claim 10, further comprising providing a second predetermined mode to be the predetermined receiving mode, wherein the second predetermined mode matches a standard protocol of a DVB-T.

19. The digital video receiving method of claim 10, further comprising providing a standard protocol of a DVB-T to be a basis of the mode modification.

20. The digital video receiving method of claim 10, further comprising providing a standard protocol of a DVB-H to be a basis of the mode modification.
